(19) United States
(12) Patent Application Publication
(10) Pub. No.: US 2008/0094375 A1
(43) Pub. Date: Apr. 24, 2008

(54) Universal flat horizontal use stylus

(76) Inventor: Jerry Craig, Cresthill, IL (US)

Correspondence Address: JERRY CRAIG, 2537 RED OAK TRAIL, CRESTHILL, IL, 60435, US

(21) Appl. No.: 11/582,079

(22) Filed: Oct. 18, 2006

(51) Int. Cl. G06F 3/033

(52) U.S. Cl. 345/179

(57) ABSTRACT

A universal flat horizontal use stylus, this stylus design avoids damage to the fragile outer membranes of existing touch sensitive screens devices mostly found on today's PDA's (personal digital assistant). Due to the curvature of the present inventions flat body and downward angled flat conical nose tip, and control/support curve at rear of present invention, the new holding angle which involves the user's index, thumb and middle fingers, most of the exertion pressure from a users hand due to the new horizontal holding angle of the present invention and flat design, impact pressure would be significantly reduced at the tip of this stylus and the fragile touch sensitive screen of today's PDA's., as one could not do with an ordinary pen-type stylus which allows for easy over exertion and damage to the delicate and fragile membrane found on most PDA's.

### CROSS-REFERENCE TO RELATED APPLICATIONS

### US PATENT DOCUMENTS

| | | |
|---|---|---|
| 4542261 A | September 1985 | behnke |
| 4927986 A | May 1990 | Daly |
| 5115401 A | May 1992 | Oyama et al. |
| 5422959 A | June 1995 | Lee |
| 4158747 A | June 1979 | Muller et al. |
| 5790308 A | August 1998 | Kamentsky |
| 6050735 A | April 2000 | hazzard |
| 5142161 A | August 1992 | brackmann |
| 5203638 A | April 1993 | redmond jr. |
| 5534671 A | July 1996 | gieut et al. |
| 5541375 | July 1996 | dam et al. |
| 210256 A | November 1878 | hoffman |
| 3479742 A | November 1969 | starkenberg |
| 4203682 A | May 1980 | hepworth |
| d286789 S | November 1986 | thompson et al. |
| 5576502 A | November 1996 | fukushima et al. |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The present invention relates to electronic pointing devices and writing instruments, more particularly to most pen-like stylus that are used with (personal digital assistants) or PDA with touch sensitive screens. A stylus is needed for writing and typing via onscreen keyboard, also for controlling a PDA function by tapping icons on desktop of the PDA. The disadvantage of using a pen-like stylus on such delicate touch sensitive screens, is that most users can't avoid applying too much pressure to the screens they are touching with the pen-like stylus, due to the nature at which the users holds and controls the pen-like stylus, damage will occur more often than not to the very delicate and expensive PDA screens. Thus there is a need for a touch screen stylus that does not subject the delicate outer membrane of the touch sensitive screens to excessive damage or undue impact pressure in normal use, the present invention overcomes this disadvantage of prior arts.

### BRIEF SUMMARY OF THE INVENTION

The present invention meets this need by providing a stylus that eliminates or greatly reduces the damage to the thin outer membranes of the touch screens in normal use, and also increases visibility of onscreen keyboards for more accurate typing on most PDA like devices. Its been discovered that the bulk of damage to touch screens in use occurs at the initial impact of the stylus against the membrane. The stylus of the present invention avoids this problem by limiting forces of impact when the stylus is brought into contact with the touch screens or similar devices. In one aspect of the invention the stylus device includes an elongated flat one piece design that can be constructed from light-weight plastics of many colors, comprising body portion tapered angled nose portion circular ring grid thumb and index finger placement grids and a middle finger control/support curve which helps user to control impact pressure and increase accuracy when pointing or typing using onscreen PDA keyboard with this invention while in use.

### BRIEF DESCRIPTION OF THE SEVERAL VIEWS OF THE FOLLOWING

These and other features, aspects, and advantages of the present invention will become better understood with references to the following description, claims, and accompanying drawings, where:

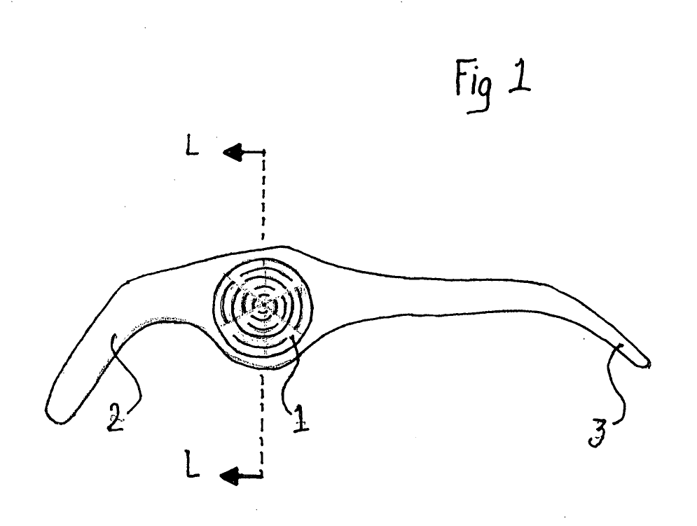

FIG. 1 is a side view of present invention in which both sides are identical. This one piece unit can be pressed or molded from light weight stiff plastics which can come in many colors.

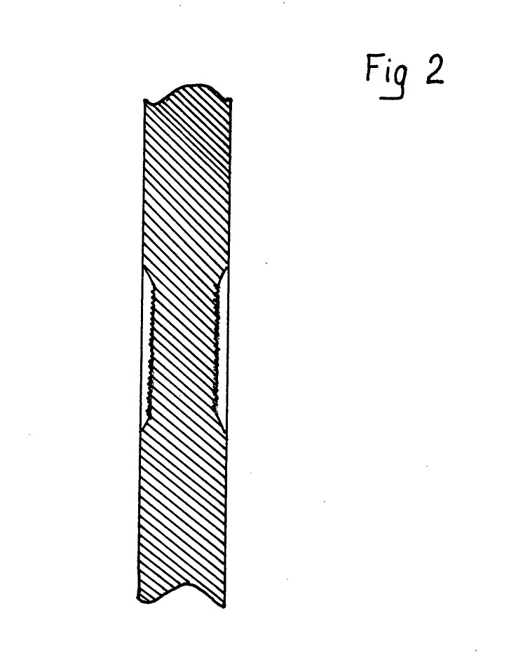

FIG. 2 is a sectional view taken along the line L_L of FIG. 1. This allows for understanding of how the index and thumb placement grid rings might appear if ground in or pressed in or heat molded into side of this flat stylus material.

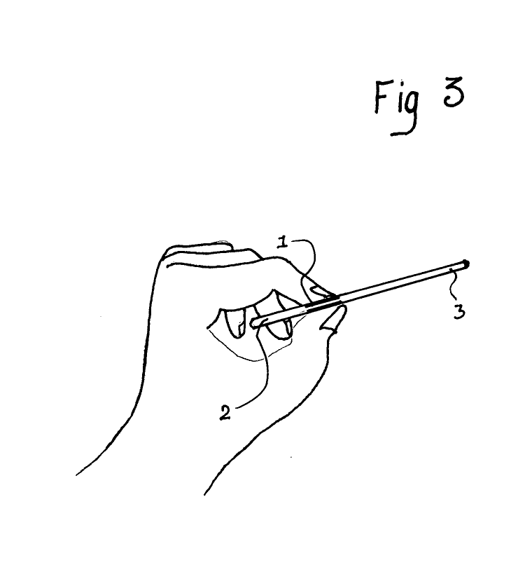

FIG. 3 is an illustration of finger placement that includes index, thumb and middle fingers, in relation to finger grids and present invention when in use.

### DETAILED DESCRIPTION OF THE INVENTION

a. a. flat horizontal body design with angled conical tip for increased visibility, comfort and accuracy when using onscreen PDA keyboards.

b. one piece construction that can be constructed from stiff lightweight plastics or any adequate materials which may be produced in many colors, this one piece design includes:

2. middle finger impact control and support curve, a thumb and index finger circular grid rings for finger placement that may be carved, molded, stamped and/or impressed into both flat sides, an angled conical nose tip.

Finger placement grid rings are indicated with impressed circular grid rings which also help to increase comfort and provide for accurate control when typing and also will prevent slippage during use.

d. Less strain on hand and fingers will be experienced by the new horizontal holding design and finger placement configuration for the user.

3. Impact energy limiting and horizontal holding design, where instead of poking at a touch sensitive screen as one would with most pen-like stylus, the user will instead lightly touch the screen from a horizontal angle and create less of an impact and as a result create less potential damage against a delicate PDA screen, user can gain improved accuracy with typing or activating on screen icons with less potential for damaging the j delicate and fragile screens with the present invention.

The stylus device of claim 1, wherein:

the stylus body is flat instead of round for ease in control and increased visibility of onscreen keyboard as one would see when view from above while typing using present invention and an the onscreen keyboard usually found on most PDA'S.

The stylus device of claim 2, wherein:

Finger placement provided and indicated with impressed circular grid rings which also help to increase comfort and provide for accurate typing, less strain on users hand and to prevent slippage during use.

The stylus device of claim 2, wherein:

Middle finger impact control and support curve is included in the one piece design, a thumb and index finger circular grid rings for finger placement that may be carved, molded, stamped and/or impressed into both flat sides. An angled curve at the rear of the present invention used for middle finger support and impact pressure reminder or control, user can sense how much pressure is being applied from the tip of the stylus to a touch sensitive screen and make adjustments accordingly thus preventing excessive impact pressure to sensitive touch screens.

The stylus device of claim 3, wherein:

Impact energy limiting and user horizontal holding design where instead of holding a stylus in a pen like fashion and poking at a touch sensitive screen the user will with present invention touch the screen from a horizontal angle and create less of an impact against the delicate PDA screen but gain improved accuracy while typing or activating on screen icon without damaging or applying excessive force to the fragile screens.

What is claimed is:

1. A Flat horizontal use stylus to be used from a horizontal angle on a touch sensitive screen, such as those found on today's PDA's, the present invention comprising:
A. a. flat horizontal body design with a downward angled conical flat tip for increased visibility, comfort and accuracy when using onscreen PDA keyboards.
B. One piece construction that can be constructed from stiff lightweight plastics or any adequate materials which may be produced in many colors, this one piece design includes:

2. middle finger impact control and support curve at rear of stylus, horizontally designed flat body, a thumb and index finger circular grid rings for finger placement that may be carved, molded, stamped and/or impressed into both flat sides near center of stylus body, a downward angled conical flat nose tip.
Finger placement grid rings are indicated with impressed circular grid rings which also help to increase comfort and provide for accurate control when typing and also will prevent slippage during use.
Less strain on hand and fingers will be experienced by the user due to the new horizontal holding angle design and finger placement configuration for the user.

3. Impact energy limiting and horizontal use holding design, where instead of poking at a touch sensitive screen as one would with most pen-like stylus, the user will instead lightly touch the screen from a horizontal angle and create less of an impact and as a result create less potential damage against a delicate PDA screen user can gain improved accuracy with typing or activating on screen icons with less potential for damaging the delicate and fragile screens with the present invention.
The stylus device of claim 1, wherein:
the stylus body is flat instead of round for ease in control and increased visibility of onscreen keyboard as one would see when view from above while typing using present invention and an the onscreen keyboard usually found on most PDA'S.
The stylus device of claim 2, wherein: this stylus is used from a horizontal angle to the PDA's touch sensitive screen, Finger placement provided and indicated with impressed circular grid rings which also help to increase comfort and provide for accurate typing, less strain on users hand and to prevent slippage during use.
The stylus device of claim 2, wherein:
middle finger impact control and support curve is included in the one piece design, a thumb and index finger circular grid rings for finger placement that may be carved, molded, stamped and/or impressed into both flat sides. An angled curve at the rear of the present invention used for middle finger support and impact pressure reminder or control, user can sense how much pressure is being applied from the tip of the stylus to a touch sensitive screen and make adjustments accordingly thus preventing excessive impact pressure to sensitive touch screens.
The stylus device of claim 3, wherein:
Impact energy limiting and user horizontal holding design where instead of holding a stylus in a pen like fashion and poking at a touch sensitive screen the user will with present invention touch the screen from a horizontal angle and create less of an impact against the delicate PDA screen but gain improved accuracy while typing or activating on screen icon without damaging or applying excessive force to the fragile screens.
